(19) United States
(12) Patent Application Publication
(10) Pub. No.: US 2017/0363006 A1
(43) Pub. Date: Dec. 21, 2017

(54) SYSTEM TO ENABLE SPRAY INTERCOOLING IN ISOCHRONOUS OPERATION FOR POWER AUGMENTATION FOR SPRAY INTERCOOLING ENGINES

(71) Applicant: General Electric Company, Schenectady, NY (US)

(72) Inventors: Roman Freidl, Houston, TX (US); Cherrylyn Aranas, Houston, TX (US)

(21) Appl. No.: 15/187,338

(22) Filed: Jun. 20, 2016

(51) Int. Cl. F02C 7/16

(52) U.S. Cl. CPC F02C 7/16; F05D 2270/71; F05D 2220/32; F05D 2260/212; F05D 2270/335

(57) ABSTRACT

A control system for a gas turbine system includes a virtual filter. The virtual filter is configured to receive a power signal of the gas turbine system having a spray intercooler. The virtual filter is configured to substantially remove sensor noise in the power signal and filter transient power changes of the gas turbine system to provide a filtered power signal. The virtual filter is configured to provide the filtered power signal to a controller of the spray intercooler, wherein the controller is configured to control operation of the spray intercooler based on the filtered power signal.

### BACKGROUND

The subject matter disclosed herein relates to gas turbines, and more particularly, to controlling operation of a spray intercooling system of a gas turbine.

Frequently in power generation, turbine systems may be used to convert fuel and an oxidant into power. For example, a gas turbine may be used to provide power to one or more loads, such as conveyor belts, blowers, motors, electric generators, or other industrial equipment. The gas turbine may use one or more compressors to provide a compressed oxidant (e.g., air, oxygen, oxygen-enriched air, or oxygen-reduced air) that is combined with a fuel and combusted to rotate blades of the turbine to produce power. Gas turbines may have a spray intercooling system to cool the temperature of the compressed oxidant entering the gas turbine. Because the spray intercooling system often uses fluids that react slower than desirable to changes in power, it is desirable to improve how spray intercooling systems react to changes in power.

### BRIEF DESCRIPTION

Certain embodiments commensurate in scope with the originally claimed disclosure are summarized below. These embodiments are not intended to limit the scope, but rather these embodiments are intended only to provide a brief summary of possible forms of the disclosure. Indeed, the disclosure may encompass a variety of forms that may be similar to or different from the embodiments set forth below.

In a first embodiment, a control system for a gas turbine system includes a virtual filter configured to receive a power signal of the gas turbine system having a spray intercooler, substantially remove sensor noise in the power signal and filter transient power changes of the gas turbine system to provide a filtered power signal, and provide the filtered power signal to a controller of the spray intercooler, wherein the controller is configured to control operation of the spray intercooler based on the filtered power signal.

In a second embodiment, a system includes a controller configured to control operations of a gas turbine having a spray intercooler, the controller comprising a processor configured to receive a power signal of the gas turbine system, apply a virtual filter to substantially remove sensor noise in the power signal and transient power changes of the gas turbine system to provide a filtered signal, and control operation of the spray intercooler based on the filtered signal.

In a third embodiment, a non-transitory computer-readable medium has computer executable code stored thereon, the code comprising instructions to receive a power signal of a gas turbine having a spray intercooler, apply a virtual filter to substantially remove sensor noise in the power signal and transient power changes of the gas turbine system to provide a filtered signal, and control operation of the spray intercooler based on the power signal.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of a gas turbine system with a controller for a spray intercooling system;

FIG. 2 is a graph of an embodiment of power signals of the gas turbine system of FIG. 1;

FIG. 3 is a schematic diagram of an embodiment of a filter for the controller of FIG. 1; and

FIG. 4 is a flow chart of an embodiment of a process performed by the controller of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The systems and methods described herein are directed to controlling a spray intercooling system of a gas turbine system. Typically, a gas turbine system may be used to provide mechanical power to one or more systems, such as motors, conveyor belts, blowers, electrical generators, or the like. To generate power, the gas turbine may combust an oxidant mixed with a fuel to rotate blades of the turbine. Frequently, the oxidant is compressed to allow the turbine to operate more efficiently. For example, the oxidant (e.g., air) may be compressed in a low pressure compressor and a high pressure compressor.

The gas turbine system may include a spray intercooling system that sprays a fluid, such as water, into the low pressure compressor and/or the high pressure compressor to reduce a temperature of the oxidant, thereby augmenting power generated by the gas turbine. For example, the spray intercooling system may control the temperature of the oxidant by spraying (e.g., via mist injection through a nozzle) the fluid atomized with air to allow heat from the oxidant to be absorbed by the fluid, as well as to increase mass flow.

To improve efficiency, the spray intercooling system may operate depending on a signal of the gas turbine, such as a power signal. For example, if a controller derives that electric power demand and/or power generated by the gas turbine suggests that the gas turbine would operate more efficiently by using the spray intercooling system, then the spray intercooling system may be turned on, e.g., via the controller. Similarly, if the controller derives that the electric power demand and/or power generated by the gas turbine suggests that the gas turbine would operate less efficiently by using the spray intercooling system, then the spray intercooling system may be turned off.

The systems that consume electric power (e.g., the grid) often expect to receive the electric power from the gas turbine system, e.g., via an electrical generator system, at a desired frequency and/or magnitude of electric power. To deliver electric power at the desired frequency and/or magnitude, the gas turbine may synchronize operation with one or more other gas turbines. To control power generated, the gas turbine system via the electrical generator may increase or decrease the frequency and/or phase angle in what is referred to as droop control.

In other cases, the gas turbine system may operate in isochronous mode, e.g., where the gas turbine is controlled to operate and maintain a set speed. For example, the gas turbine may operate at 3600 RPM to power the mechanically coupled systems described above, such as the electrical generator. In such cases, when operating in isochronous mode, the gas turbine system may operate standalone and not part of a citywide, statewide, or regional grid. While isochronous mode allows the gas turbine system to operate at a set speed, isochronous mode frequently involves adjusting power generated by the turbine system to account for changes in power demand from the loads. For example, a conveyor belt may operate using electric power received from the gas turbine via the electrical generator while operating in isochronous mode. When the conveyor belt is turned on, the turbine system may increase power generated to match an increase in the power demand. The power change may be a step increase or other rapid power change (e.g., instantaneous change). As the spray intercooling system operates based on the power signal of power demand and/or power generation, the power changes can cause the spray intercooling system to turn on and/or off to decrease the efficiency that the spray intercooling system provides. For instance, the power signal may overshoot or undershoot a steady state power level. Further, the power signal may include noise from the sensor, sampling, or the like. By including the filter, removing sensor noise may enable the spray intercooling system to operate in isochronous mode and to provide an increase in output (e.g., 0-5%).

As described herein, a virtual “filter” may be included to oversee the overshoots, undershoots, and/or sensor noise in the power signal to enable the spray intercooling system to operate during changes in electrical power demand and/or power generation when operating in isochronous mode. The filter may be configured to receive a power signal of a gas turbine. The filter may attenuate noise in the power signal from a sensor and power changes of the gas turbine. The filter may provide a transformed signal to the controller of the spray intercooling system where the transformed signal prevents the spray intercooling system from shutting off and/or turning on due to the overshoots, undershoots, and/or sensor noise.

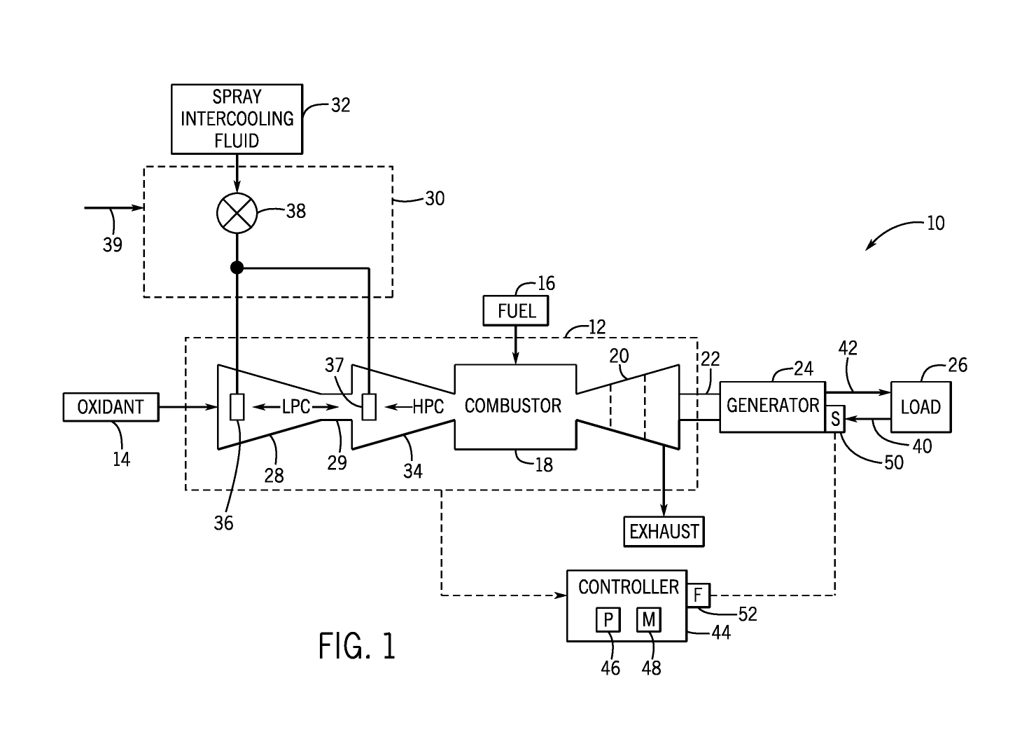

Turning to the figures, FIG. 1 is a schematic diagram of a power generation system 10 that includes a gas turbine system 12. The gas turbine system 12 may receive an oxidant 14 (e.g., air, oxygen, oxygen-enriched air, or oxygen-reduced air) and a fuel 16 (e.g., gaseous or liquid fuel), such as natural gas, syngas, or petroleum distillates. The oxidant 14 may be pressurized and combined with the fuel 16 to be combusted in a combustor 18. The combusted oxidant-fuel mixture may then be used to apply forces to blades of a turbine 20 to rotate a shaft 22 that is used by a generator 24 to provide electrical power to one or more loads 26.

The gas turbine system 12 may include one or more compressors that increase the pressure of the oxidant 14 to improve efficiency during combustion. While two compressors are used herein, this is merely an example and any suitable combination of compressors may be used, such as a one, two, three (e.g., low pressure compressor, intermediate pressure compressor, and high pressure compressor), or more compressors. As depicted in FIG. 1, the gas turbine system 12 includes a low pressure compressor 28 and a high pressure compressor 34. The low pressure compressor may be coupled to the high pressure compressor 34 via a conduit 29. The oxidant 14 may enter the low pressure compressor 28 to be compressed before entering the conduit 29 to be further compressed by the high pressure compressor 34.

The power generation system 10 may include a spray intercooling system 30 or an efficient spray intercooling system. The spray intercooling system 30 may reduce the temperature of the oxidant 14 in the one or more of the compressors 28 and 34 by providing a spray intercooling fluid 32, such as water, into the air flow. That is, the spray intercooling system 30 may be configured to inject water into the one or more of the compressors 28 and 34 to increase a compression ratio, thereby increasing the power output. Spray intercooling may also be referred to as wet-compression. As an example, the spray intercooling system 30 may include one or more spray nozzles 36 and 37 to spray a mist of the spray intercooling fluid 32 mixed with air to transfer heat from the oxidant 14 to the mist. Further, the spray nozzles 36 and 37 may be mounted to a front frame, an inlet, or any suitable location on the compressors 28 and 34. In some embodiments, the spray intercooling system 30 may use air (e.g., the oxidant 14) extracted from the high pressure compressor 34 to atomize the spray intercooling fluid 32 into a mist.

The supply of the spray intercooling fluid 32 may include a variety of components for flow control, flow distribution, and fluid treatment. The fluid supply may include a storage tank, a conduit, a freshwater source (e.g., a lake or river), a plant component (e.g., equipment in a power plant that provides a process fluid), a pump, a valve, a distribution manifold, a fluid treatment system (e.g., filter, solid-liquid separator, gas-liquid separator, and/or chemical absorber), or the like.

A flow of the spray intercooling fluid 32 from a supply to the nozzles 36 and 37 may be controlled based on a signal 39. For example, the signal 39 may be a signal sent to a turn the spray intercooling system 30 on or off. Further, the signal 39 may be used by the spray intercooling system 30 to control a valve 38, a solenoid, pump, or the like. To control the flow of the spray intercooling fluid 32 from the supply to the nozzle 36 and 37, the valve 38 may be opened or closed based depending on the signal 39.

The high pressure compressor 34 may further compress the oxidant that is misted by the spray intercooling system 30 before combustion in the combustor 18. The combustor 18 may be coupled to one or more turbines 20, such as a low pressure, medium pressure and/or high pressure turbine. While FIG. 1 shows three turbines, any number of turbines may be included in the power generation system 10. For example, the gas turbine system 12 may include 1, 2, 3, 4, or more turbines. The combusted air-fuel mixture creates forces on blades of the turbine to rotate the shaft 22. The rotation of the shaft 22 enables the generator 24 to provide power to one or more loads 26. The gas turbine system 12 may be used to generate power for one or more industrial loads, such as a conveyor belt, a blower, a motor, or the like.

The power generation system 10 may include a controller 44 to control operations of the gas turbine system 12, the spray intercooling system 30, the generator 24, or the like. For example, the controller 44 may be a redundant controller having three processing cores (e.g., R, S, T cores) that may redundantly control an amount of oxidant 14 and an amount of fuel 16 (e.g., air-fuel ratio) that are used in the combustion process. Indeed, the controller 44 may include a processor 46 or multiple processors, memory 48, and inputs/outputs (i.e., I/O). The processor 46 may be operatively coupled to the memory 48 to execute instructions for carrying out the presently disclosed techniques. These instructions may be encoded in programs or code stored in a tangible non-transitory computer-readable medium, such as the memory 48 and/or other storage. The processor 46 may be a general purpose processor (e.g., processor of a desktop/laptop computer), system-on-chip (SoC) device, or application-specific integrated circuit, or some other processor configuration. The memory 48, in the embodiment, includes a computer readable medium, such as, without limitation, a hard disk drive, a solid state drive, diskette, flash drive, a compact disc, a digital video disc, random access memory (RAM), and/or any suitable storage device that enables the processor 46 to store, retrieve, and/or execute instructions and/or data. The memory 48 may include one or more local and/or remote storage devices. The controller 44 may include a wide variety of inputs/outputs (i.e. I/O) to receive and/or transmit one or more signals. For instance, the I/O may allow the controller 44 to receive and/or send one or more signals from spray intercooling system 30, the gas turbine system 12, the generator 24, and/or one or more loads 26. As an example, the I/O may receive a power signal from a sensor 50 indicating power demand, power generated, or the like. While the sensor 50 is shown coupled to the generator 24, sensors may be located on the gas turbine system 12, the spray intercooling system 30, or any other suitable location. As a further example, the sensor 50 may be a high pressure compressor exhaust pressure sensor (e.g., PS3 sensor).

The processor 46 may control the power, e.g., electrical power, generated 42 by the gas turbine system 12 to power the loads 26. Each of the loads 26 may utilize various amounts of power. For example, when a conveyor belt is turned on, a power demand signal 40 may indicate an increase in power demand of the loads 26. When operating in isochronous mode, it is desirable to increase power generated 42 according to increases in power demand. Moreover, the processor 46 may control parameters of the gas turbine system 12, the spray intercooling system 30, and/or the generator 24 to control the power generated 42 by the generator 24 based on changes in the power demand signal 40. For example, when in isochronous mode, if the power demand signal 40 indicates increases in power demand, the processor 46 may control the gas turbine system 12 to utilize additional fuel 16 and/or oxidant 14 to maintain the speed of the turbines 20. For instance, the processor 46 may send the signal 39 to turn off or turn on the spray intercooling system 30 to control flow of the spray intercooling fluid 32 and thereby regulating temperature of the oxidant 14.

However, by turning on and/or turning off industrial loads when in isochronous operations, one of the power signals (e.g., power demand signal 40, generated power signal 42, etc.) may change (e.g., increase or decrease) faster than the spray intercooling system 30 can change the cooling rate of the oxidant 14. In other words, the spray intercooling fluids 32 of the spray intercooling system 30 may not be designed to account for rapid changes in power demand and/or generation. Moreover, the power signal may include noise from the sensor 50 and/or a transient acceleration power that may cause overshoots and/or undershoots in controlling the spray intercooling system 30. Removing sensor noise may enable the spray intercooling system to operate in isochronous mode and to provide an increase in output.

For the processor 46 to control the spray intercooling system 30, the power signal may be transformed by a virtual filter 52. The filter 52 may include a Tustin filter, a Euler filter, or the like. The filter 52 may be a first order lag filter that transforms a frequency response of the power signal by substantially removing sensor noise and/or substantially removing transient power changes of the gas turbine system 12 to provide a filtered power signal. For example, the first order lag filter may attenuate the power signal at one or more cutoff frequencies. The filter 52 may include circuitry separate from the controller 44 to provide a filtered power signal to the controller 44. Alternatively and/or additionally, the filter 52 may include instructions stored in the memory 48 of the controller 44 and executed by the processor 46 (e.g., running code) to filter the power signal. The processor 46 may then control the spray intercooling system 30 based on the filtered power signal to improve efficiency of the gas turbine system 12.

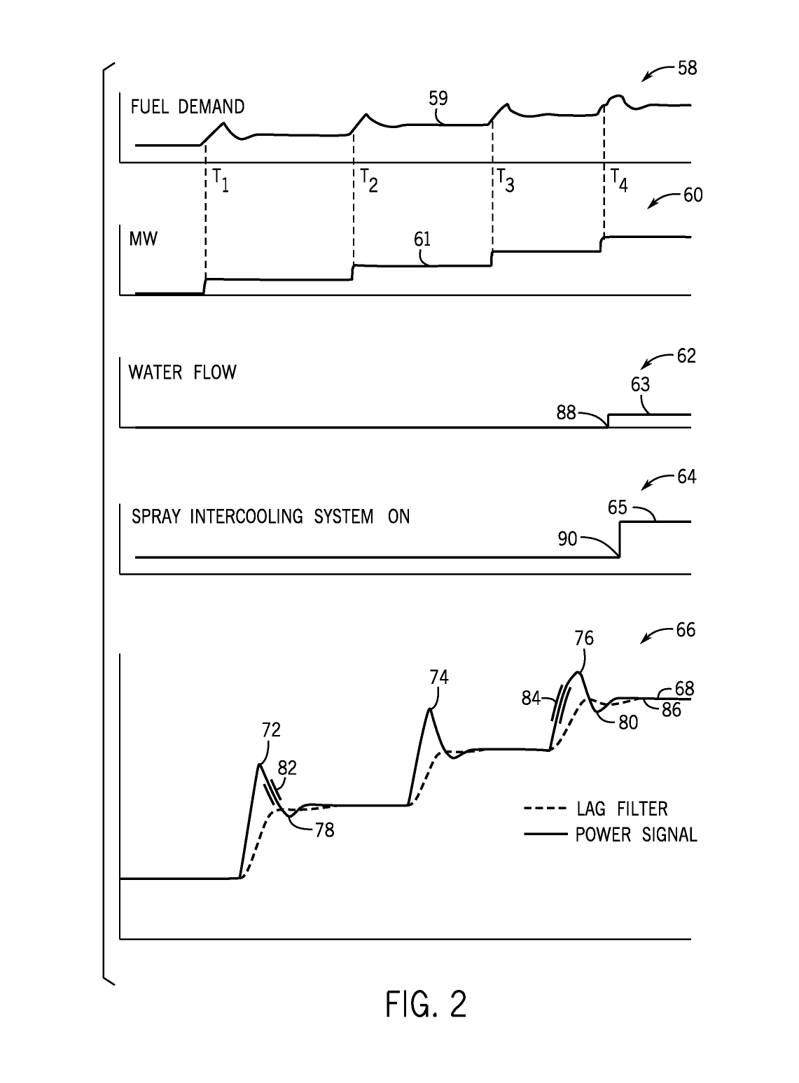

To control operation of the spray intercooling system 30, the gas turbine system 12, and/or the generator 24, the processor 46 may send and/or receive one or more signals. FIG. 2 is a set of graphs of various signals that may be utilized by the processor 46 of the controller 44. While these graphs may be viewed on a display of the controller 44, the processor 46 may perform the methods described herein without displaying the graphs. Moreover, it should be noted that these graphs are examples used to illustrate the processes herein, and other signals and inputs may be used.

Graph 58 shows an example of demand signal 59 of fuel 16 for the gas turbine system 12. As shown in FIG. 2, at various times T1, T2, T3, and T4, fuel demand increases. These increases may correspond to increases in power demand indicated in the power demand signal 40. For example, one or more electric motors may be turned on at each of times T1, T2, T3, and T4 which cause an increase in power demand for the gas turbine system 12 to provide. To generate additional power to meet the increased power demand, the fuel demand of the gas turbine system 12 may rise as shown in graph 58.

Graph 60 shows an example of a reference signal 61 of a power set point of the gas turbine system 12, with an x-axis representative of time and a y-axis representative of signal 61 strength. When in isochronous mode, the power set point provides a desired power for the gas turbine system 12 to produce to maintain the desired speed. As shown in graph 60, the changes in power that the gas turbine system 12 is desired to produce can be rapid changes (e.g., step changes). For example, prior to time T1, a motor may be initially off. When the motor is turned on after time T1, the gas turbine system 12 is asked to produce additional power to maintain speed. Similar events may occur at T2, T3, and T4 when additional equipment is turned on.

Graphs 62, 64, and 66 show examples of signals 63, 65, 68 that may be used by the processor 46 to control the spray intercooling system 30. The graphs include x-axes that are aligned with each other in time and y-axes that include increasing signal strength. For example, graph 66 includes a power signal 68 that indicates power demand or power generation of the gas turbine system 12. If the processor 46 utilizes the power signal 68 to control the spray intercooling system 30, then the processor 46 may send a signal to turn on the spray intercooling system 30 due to the power overshoots at time points 72, 74, and 76 or turn off the spray intercooling system 30 due to undershoots at time points 78 and 80 caused by transient load changes (e.g., oscillation, underdamping, etc.). Further, due to the noise 82 and 84 from the sensors 50 of the power signal 68, the spray intercooling system 30 may turn on and/or turn off. However, controlling operation of the spray intercooling system 30 based on the overshoots 72, 74, and 76, the undershoots 78, 80, and/or the signal noise 82 and 84 would decrease the efficiency of the gas turbine system 12 due to expending more energy to operate the spray intercooling system 30 than energy saved from a cooler oxidant 14 by operation of the spray intercooling system 30.

The processor 46 may increase spray intercooling system 30 efficiency by utilizing the virtual filter 52. The filter 52 of the controller 44 may transform the transient overshoots, undershoots, and/or signal noise to provide a filtered (e.g., smoothed) power signal 86, among other properties. For example, the processor 46 may receive the filtered power signal 86 and use the filtered power signal 86 to control operation of the spray intercooling system 30. By controlling the spray intercooling system 30 with the filtered power signal 86 that does not include the overshoots 72, 74, and 76, the undershoots 78 and 80, and the signal noise 82 and 84, the processor 46 may operate the spray intercooling system 30 in a more efficient manner by turning on and/or off the spray intercooling system 30 based on a signal that more accurately represents a steady state load than the unfiltered. As such, the filter 52 provides the filtered power signal 86 to the processor 46 where the filtered power signal 86 prevents the spray intercooling system 30 from shutting off or turning on based on overshoots or undershoots caused by transient load changes or sensor noise. As shown in FIG. 2, the processor 46 may turn on the spray intercooling system 30 and control flow of the spray intercooling fluid 32, via the valve 38, to the nozzles 36 and 37 at points 88 and 90 based on the steady state load changes represented in the filtered power signal 86. That is, the filtered power signal 86 allows the processor 46 to operate the spray intercooling system 30 based on steady state power during power changes from loads. By preventing the spray intercooling system 30 from shutting off and/or turning on based on inaccuracies in the power signal 68, the gas turbine system 12 may save energy through operation of the spray intercooling system 30, thereby enabling the spray intercooling system 30 to operate in isochronous mode and to provide an increase in output.

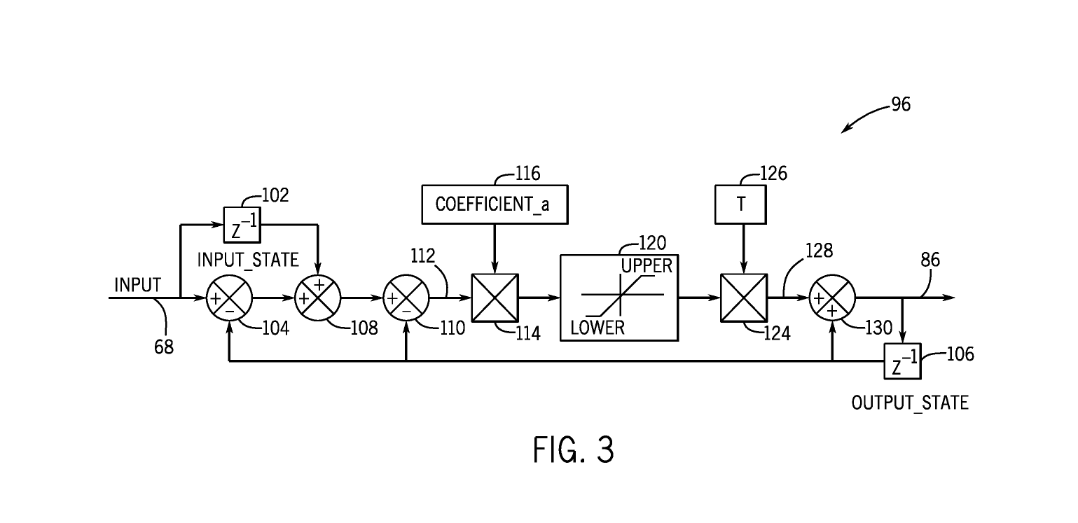

The filter 52 may be a Tustin filter that smoothes both transient load changes and sensor noise. FIG. 3 is a diagram of an embodiment of a process 96 (e.g., virtual filter) including a Tustin filter performed by filter circuitry and/or the processor 46 to utilize the power signal 68 to provide the filtered power signal 86 for the processor 46 to control the spray intercooling system 30. The process 96 may be stored in the memory 48 of the controller 44 and executed as instructions by the processor 46 (e.g., running code). The processor 46 may begin by receiving the power signal 68 indicating power demand or power generated by the power generation system 10. The processor 46 may store an input state value 102 of the power signal 68 in the memory 48. Further, the processor 46 may determine a compared value by comparing the input value of the power signal 68 with an output state value 106 (e.g., previous output) at comparator 104. The processor 46 may then add the compared value with the input state value 102 at adder 108, which is then compared at a second comparator 110 to the output state value 106 to determine a resultant value 112 (i.e. result). The additions and subtractions to determine the resultant value 112 are illustrated in the equation below:

result=(((input−output state)+input state)−output state) (1)

The processor 46 may then multiply the resultant value 112 by a filter coefficienta 116 at multiplier 114. By using a Tustin filter, the processor 46 may utilize the filter coefficienta 116 with a time constant and a sampling time. For example, the filter coefficient may be determined using the following equation:

$${coefficient}_{a} = \frac{1}{2 τ + T} \qquad ( 2 )$$

In equation (2), τ may be a time constant of the filter and T may be the sampling time (e.g., a scan rate of the code routine). By accounting for the sampling time in the filter coefficient, the Tustin filter may reduce signal noise in the power signal at or approximately near the sampling time to provide the filtered power signal 86 that is used to improve operation of the spray intercooling system 30. For example, if a sample were taken at 40 milliseconds intervals (e.g., 25 Hz or approximately 20-30 Hz), the filtered power signal 86 may filter noise at or near (e.g., within 5 Hz, 10 Hz, 20 Hz) 25 Hz (e.g., filter noise above 10 Hz, 15 Hz, 20 Hz, etc.). This can allow the controller 44 to operate at a sampling frequency where noise may otherwise cause the spray intercooling system 30 to shut off or turn on. By removing noise that can cause the controller 44 to shut off and/or turn on, efficiency of the gas turbine system 12 may be improved.

The resultant value 112 may then be limited by a limiter 120 to limit the resultant value 112 value to maximum and/or minimum values. The processor 46 may then multiply the resultant value 112 by the sampling time T 126 at multiplier 124. For example, the sampling time may be 4 seconds or other desired value (e.g., 000.1 to 40 seconds). The resultant value 112 may then be added to the output state value 106 at adder 130 to generate the filtered power signal 86 as the output. The filtered power signal 86 may then be stored as the next output state. The filtered power signal 86 may then be used by the processor 46 to control the spray intercooling system 30.

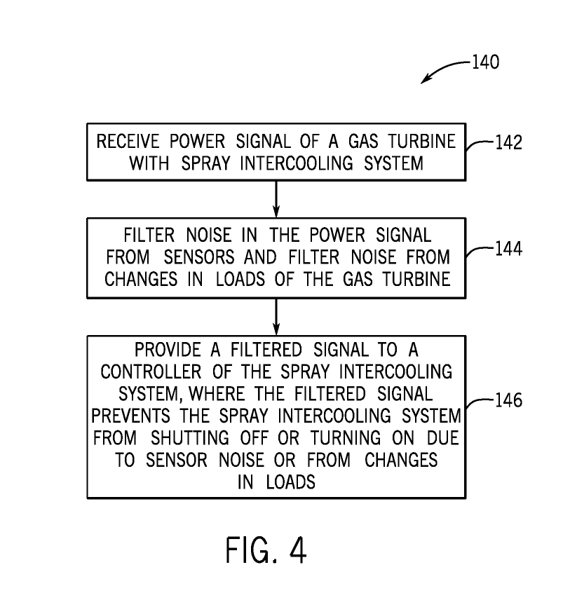

FIG. 4 is a diagram of an embodiment of a process 140 performed by the virtual filter 52. One or more steps of the process 140 may be stored in the memory 48 of the controller 44 and executed as instructions by the processor 46 (e.g., running code). The filter 52 may receive a power signal of the gas turbine system 12 with an spray intercooling system 30 (block 142). The filter 52 may substantially remove, via the filter circuitry and/or the processor 46, noise in the power signal from sensors and filter noise from changes in loads of the gas turbine 12 (block 144). Then the filter 52 may provide, via the filter circuitry and/or the processor 46, a filtered signal to the controller 44 of the spray intercooling system 30, where the filtered signal prevents the spray intercooling system 30 from shutting off or turning on due to sensor noise or noise from changes in loads (block 146).The gas turbine system 12 may control operation of the gas turbine based on the filtered signal to prevent the gas turbine from shutting down or turning on due to power changes (e.g., noise or oscillations due to changes in loads).

Technical effects of the present embodiments relate to gas turbine systems using a spray intercooling system. A controller of the gas turbine system controls whether the spray intercooling system cools an oxidant entering the gas turbine system. In some embodiments, the controller may include a filter that provides a filtered power signal to control the spray intercooling system. By using the filtered power signal from the filter, the spray intercooling system may operate when the spray intercooling system would provide more power than it uses. As such, the spray intercooling system may operate in isochronous mode to provide increased power output. By sending a filtered power signal to the gas turbine system in real time, the controller may provide a post-solution activity in controlling operation of the turbine based on the filtered power signal.

This written description uses examples to disclose various embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A control system for a gas turbine system, comprising:
a virtual filter configured to:
receive a power signal of the gas turbine system having a spray intercooling system;
substantially remove sensor noise in the power signal and filter transient power changes of the gas turbine system to provide a filtered power signal; and
provide the filtered power signal to a controller of the spray intercooling system, wherein the controller is configured to control operation of the spray intercooling system based on the filtered power signal.

2. The control system of claim 1, wherein the virtual filter comprises a Tustin filter configured to reduce signal noise in the power signal at or approximately near a sampling frequency.

3. The control system of claim 2, wherein the Tustin filter comprises a filter coefficient calculated based on a time constant and a sampling time.

4. The control system of claim 2, wherein the sampling frequency is between 20 and 30 Hz, and wherein the Tustin filter reduces noise between 10 Hz and 25 Hz.

5. The control system of claim 1, wherein the controller is configured to control shut off and turn on of the spray intercooling system based on the filtered signal.

6. The control system of claim 1, wherein the controller is configured to operate the spray intercooling system in isochronous mode associated with step changes in power demand, power generation, or any combination thereof.

7. The control system of claim 1, wherein the filtered signal allows the controller to operate based on steady state power during power changes from loads.

8. The control system of claim 1, wherein the virtual filter is configured to filter transient power changes by reducing transient overshoots and undershoots during changes in power demand.

9. The control system of claim 1, wherein the virtual filter comprises a first order lag filter.

10. A system, comprising:
a controller configured to control operations of a gas turbine having a spray intercooling system configured to spray a fluid into air flow of the gas turbine, the controller comprising a processor configured to:
receive a power signal of the gas turbine system;
apply a virtual filter to substantially remove sensor noise in the power signal and transient power changes of the gas turbine system to provide a filtered signal; and
control operation of the spray intercooling system based on the filtered signal.

11. The system of claim 10, wherein the processor is configured to substantially remove signal noise in the power signal at or approximately near a sampling frequency.

12. The system of claim 10, wherein the processor is configured to utilize a filter coefficient based on a time constant and a sampling time.

13. The system of claim 10, wherein the processor is configured to control shut off and turn on of the spray intercooling system based on the filtered signal.

14. The system of claim 10, wherein processor is configured to substantially remove transient power changes by reducing transient overshoots and undershoots during changes in power demand.

15. The system of claim 10, wherein the processor is configured to operate the spray intercooling system in isochronous mode.

16. A non-transitory computer-readable medium having computer executable code stored thereon, the code comprising instructions to:
receive a power signal of a gas turbine having a spray intercooling system, wherein the spray intercooling system is configured to spray a fluid into air flow of the gas turbine;
apply a virtual filter to substantially remove sensor noise in the power signal and
transient power changes of the gas turbine system to provide a filtered signal; and
control operation of the spray intercooling system based on the power signal.

17. The non-transitory computer-readable medium of claim 15, wherein the code comprises instructions to substantially remove transient power changes by reducing transient overshoots and undershoots during changes in power demand.

18. The non-transitory computer-readable medium of claim 15, wherein the code comprises instructions to substantially reduce the sensor noise at or approximately near a sampling frequency.

19. The non-transitory computer-readable medium of claim 15, wherein the code comprises instructions to operate the spray intercooling system in isochronous mode associated with step changes in power demand.

20. The non-transitory computer-readable medium of claim 15, wherein the code comprises instructions to control operation of the spray intercooling system by turning on or shutting off the spray intercooling system based on the power signal operating at a steady state.
